(19) United States
(12) Patent Application Publication
(10) Pub. No.: US 2005/0288835 A1
(43) Pub. Date: Dec. 29, 2005

(54) Tire measurement system and method

(76) Inventor: John Holland, Conroe, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 10/878,195

(22) Filed: Jun. 28, 2004

(51) Int. Cl. G01M 17/00

(52) U.S. Cl. 701/29; 701/1

(57) ABSTRACT

A system, device, and method are provided that relate to the measurement of tires on vehicles. In at least one example, such as system includes: a sensor having a sensing direction of travel that is at a non-zero angle to an anticipated travel path, and a switch positioned and arranged for activation upon a tire reaching the sensor. Such an arrangement has been found to increase the accuracy and repeatability of the measurements taken with, for example, a horizontal sensor bar suspended on springs.

### BACKGROUND

The present invention relates generally to detecting tire angles, alignment, wear, etc. Specifically, the present invention relates to a system, device and method for use with a tire under load.

A variety of tire alignment and wear indicators have been proposed. For example, U.S. Pat. No. 6,151,562 shows the use of a rotating laser, to determine wheel camber and toe without rotation of the tire. U.S. Pat. No. 5,168,632 also describes camber, toe, and caster measurements, while U.S. Pat. No. 4,547,945 describes an alignment system. U.S. Pat. No. 6,438,855 illustrates a motorcycle alignment system, and U.S. Pat. No. 6,532,811 shows a system for testing tires by simulation, inside, of outside wear conditions. All of the above-referenced patents are incorporated herein by reference. None of these, however, are slide-slip or “scrub” testers. Such a measurement is difficult to make accurately and repeatably, especially of a tire that is rolling under a load.

A further patent of interest is U.S. Pat. No. 5,522,144 showing a dynamic wheel alignment condition system for measuring the side movement of wheels attached to a common axle. However, such a design has failed to give accurate and repeatable measurements of a high quality. Others have also proposed side-slip testers; for example, an organization commonly known as “Hunter” has marketed a SS100T Computerized Sideslip Meter that measures heavy-duty vehicle side-slip as an indication of toe by driving a vehicle on floating plates to acquire an indication of side-slip for an axle. This design, as the '144 patent design, fails to give accurate, repeatable test results and has be further disadvantage of testing the tire in an unnatural state by being driven over floating plates.

There is, therefore, a need to provide for accurate and repeatable measurement of the side-slip or the “scrub.” There is a further need to be able to accurately test a tire under naturally-loaded conditions.

### SUMMARY

To address the above and other issues, alone or in combination, various examples of the invention are summarized. In at least one such example, a tire measurement device is provided comprising: a sensor having a sensing direction of travel that is at a non-zero angle to an anticipated travel path, and a switch positioned and arranged for activation upon a tire reaching the sensor. In at least one, more specific example, the sensor comprises an elongate member having a rough tire-engagement edge (e.g., a cerated or “saw-toothed” edge) and a sensing direction of travel that is substantially perpendicular to the anticipated travel path. In some such examples, the sensor comprises a substantially inverted T-bar in cross-section. In other examples, the cross-section is substantially triangular; while, in still further examples, the cross-section is substantially L-shaped

In many examples, the sensor bar has an activation direction of travel different from the sensing direction of travel; in further examples, the activation direction of travel is substantially vertical. In some examples, the sensor bar is biased in an at least partially vertical direction and the bias comprises: a first spring mounted between a first end of the sensor bar and a first spring mount of a sensor station and a second leaf-spring mounted between a second end of said sensor bar and a second spring mount of a sensor station. In at least one example, the springs comprise leaf springs. Coil springs may be used in further examples. To provide lateral travel, some leaf spring examples use rollers, attached to the spring mounts, whereby the springs are capable of lateral sliding along the rollers.

In some further examples, a sensor return is provided that comprises at least one piston positioned between the sensor and a piston mount on the sensor station. In some cases, the sensor return comprises a mechanical bias (e.g., at least one spring).

In many examples, the switch that is activated when the tire reaches the sensor is positioned for activation by a vertical motion of the sensor; the switch activation causes a sensor bar measurement component to generate a signal representative of lateral motion of the sensor.

In some further examples, a further sensor is provided having a sensing direction of travel that is at a non-zero angle to the anticipated travel path of a substantially parallel tire (for example, on the same axle as the first tire), and a further switch is positioned and arranged for activation upon a the substantially parallel tire reaching the further sensor.

In still further examples, a sensor housing is also provided that has a vehicle-weight-carrying top in which a slot has been formed; the sensor protrudes from the slot. In at least one such example, the switch is connected to the sensor housing, under the vehicle-weight-carrying top, and is sensitive to vertical motion of the sensor. In at least one such example, an approach ramp and an exit ramp are connected to the sensor housing. In some examples, the sensor housing further comprises a base plate and/or a sensor housing leveler (e.g., a base plate and filler, such as grout, epoxy, etc.).

According to still another example of the invention, a sensor station for tire measurement is provided comprising: a sensor housing having a slot therein, a sensor protruding through the slot, a switch activated upon tire-induced motion of the sensor mounted in the sensor housing, and a housing base. The housing base comprises a base plate, in many examples, and the sensor comprises an elongate plane having a top, tire-engaging edge wherein the plane is connected to a support plane along a bottom edge. In some examples, the sensor further comprises deflectors over the support plane to avoid accumulation of debris.

In still further examples of the invention, a system is provided for tire measurement that includes a left tire-scuffing sensor activated and recorded upon contact by a left vehicle tire, a right tire-scuffing sensor station activated and recorded upon contact by a right vehicle tire, and a display of information dependant upon readings from the left and the right scuffing sensors. In some examples, a computer is provided that monitors the left and the right scuffing sensors and displaying the information.

In still another example of the invention, a method is provided for determining tire tendency to side-slip. In many examples, the method includes: detecting a tire at a sensor, allowing the sensor, when in contact with the tire and with the tire in a loaded state, to move in a substantially horizontal direction to the travel path of the tire, and recording horizontal motion of the sensor as a result of said detecting. In some examples, the method also includes terminating the recording in response to loss of contact between the tire and the sensor and the detecting comprises activating a switch responsive to vertical motion of the sensor. In still further examples, the method also includes detecting a further tire at a further sensor, allowing the further sensor, when in contact with the tire and with the tire in a loaded state, to move in a substantially horizontal direction to the travel path of the tire, and recording horizontal motion of the further sensor as a result of said detecting the further tire, wherein the tire angle to a travel path of the tire is determined dependant upon said recording.

In many examples, the method further includes displaying of the travel path of the tire and the tire angle in contrasting colors, determining of a further tire angle to the travel path of a further tire on an axle in common between the tires, and displaying the further tire angle to the travel path substantially simultaneously as the displaying of the travel path of the tire. In still further examples, the method also comprises displaying all tire angles to the travel path of a vehicle substantially simultaneously and/or displaying all angles in contrasting colors.

In yet a further example of the invention, a system is provided for determining tire tendency to side-slip, the system comprising: means for detecting a tire at a sensor, means for allowing the sensor, when in contact with the tire and with the tire in a loaded state, to move in a substantially horizontal direction to the travel path of the tire, and means for recording horizontal motion of the sensor as a result of said detecting. In at least one such example, the system further comprises means for terminating the recording in response to loss of contact between the tire and the sensor, wherein said means for detecting comprises means for activating a switch responsive to vertical motion of the sensor and wherein said means for detecting comprises means for monitoring a photo switch positioned to be obscured by a tire upon contact by the tire with the sensor. In a further example, the system also includes means for detecting a further tire at a further sensor, means for allowing the further sensor, when in contact with the tire and with the tire in a loaded state, to move in a substantially horizontal direction to the travel path of the tire, and/or means for recording horizontal motion of the further sensor dependant upon said means for detecting the further tire.

In at least one other example, the system also includes a means for determining the tire angle to a travel path of the tire dependant upon said means for recording, and/or means for displaying of travel path of the tire and the tire angle in contrasting colors. While, in yet a further example, the system also includes means for determining a further tire angle to the travel path of a substantially parallel tire and means for displaying the further tire angle to the travel path substantially simultaneously as the displaying of the travel path of the tire. In some such examples, the system also includes means for displaying all tire angles to the travel path of a vehicle substantially simultaneously and means for displaying all angles in contrasting colors.

Additional features and advantages of the examples of the invention will be understood from the description below and may be obtained by combinations of the various components of the examples.

### BRIEF DESCRIPTION OF THE DRAWINGS

FIG. 1 is a plan view of an example embodiment of the invention.

FIG. 1A is a plan view of an example embodiment of the invention.

FIG. 2 is a top view of an example embodiment of the invention.

FIG. 2A is a sectional view of the example embodiment of FIGS. 2 through line 2A of FIG. 2.

FIG. 2B is a side view of an example embodiment of the invention.

FIG. 3 is a top view of an example embodiment of the invention.

FIG. 3A is a side view of an example embodiment of the invention.

FIG. 3B is a front view of an example embodiment of the invention.

FIGS. 3C and 3D are cross-sectional views of alternative embodiments of component 16 of FIG. 3.

FIG. 4 is a top view of an example embodiment of the invention.

FIG. 4A is a sectional view of the example embodiment of FIGS. 4 through line 4A of FIG. 4.

FIG. 4B is a side view of an example embodiment of the invention.

FIG. 5 is a top view of an example embodiment of the invention.

FIG. 5A is a side view of the example embodiment of FIG. 5.

### DETAILED DESCRIPTION OF EXAMPLE EMBODIMENTS

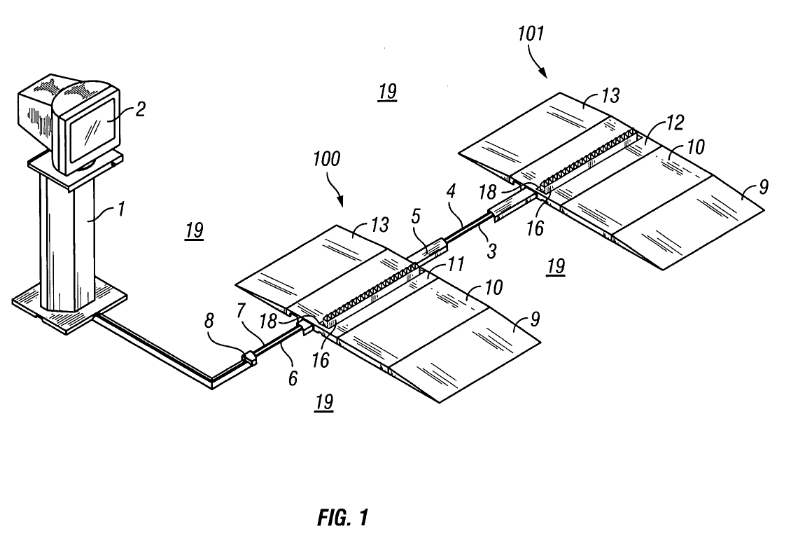

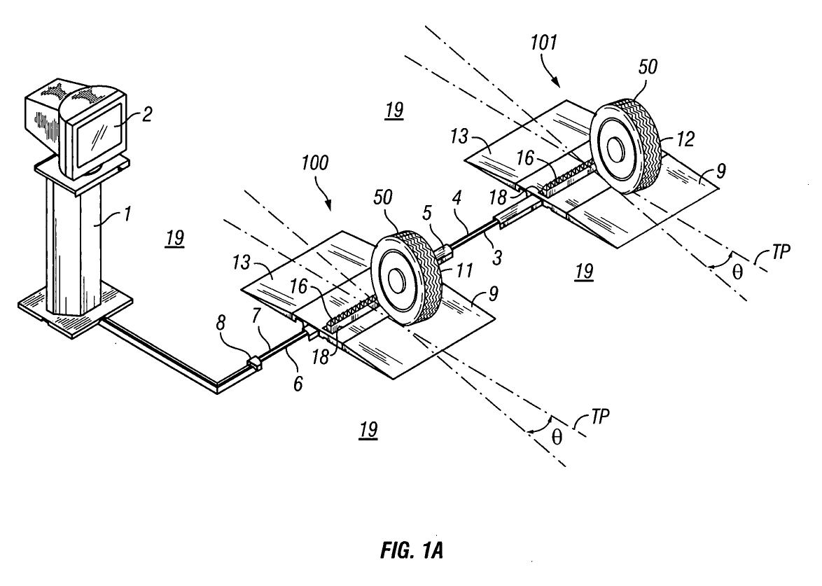

FIG. 1 illustrates an example embodiment of the invention, in which a tire wear detection system is seen, comprising: left and right ramps 100 and 101, a console pedestal 1 which houses a system control console computer with a color video display 2 and, in some examples, a printer (not shown). A ramp-to-ramp interconnect housing 5 is also seen, as is a ramp-to-pedestal interconnect housing 8. Each ramp, in the illustrated example, is attached to a solid floor surface 19 that a vehicle can travel over. In various alternative embodiments, the two ramps 100 and 101 are mounted in different positions on the solid floor surface 19 to additionally provide for a more narrow track or wider track vehicle. In still further examples, ramps 100 and 101 are modified to be flush with surface 19 or even recessed. Such alternative embodiments and other locations for sensors (described below) will occur to those of skill in the art.

Referring still to the example of FIG. 1, ramps 100 and 101 are electrically and pneumatically interconnected by electric cables 3 and pneumatic hoses 4 contained within the ramp-to-ramp interconnect housing 5.

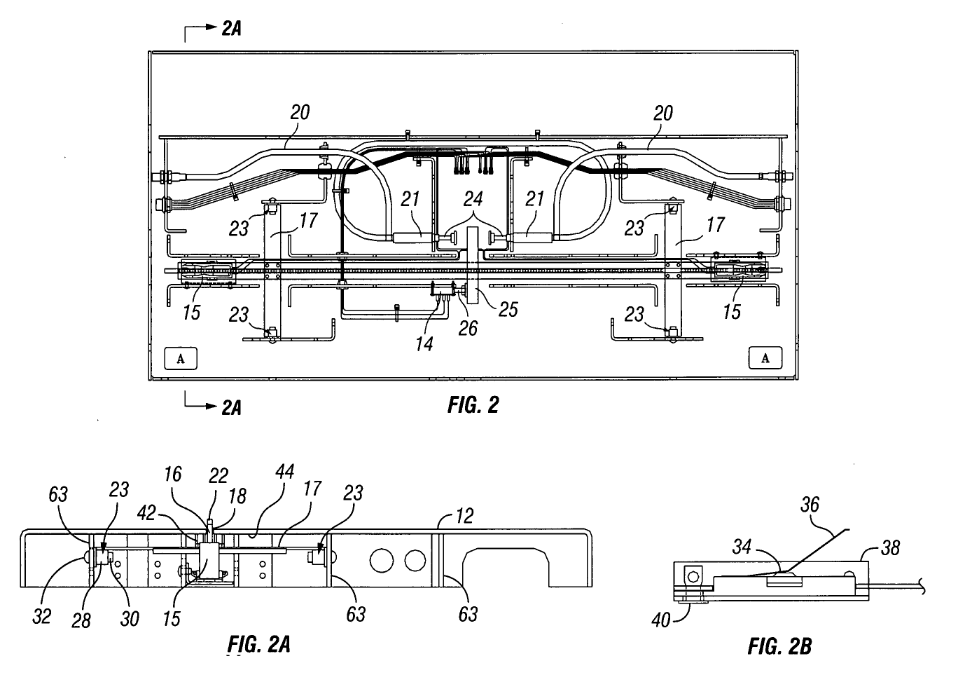

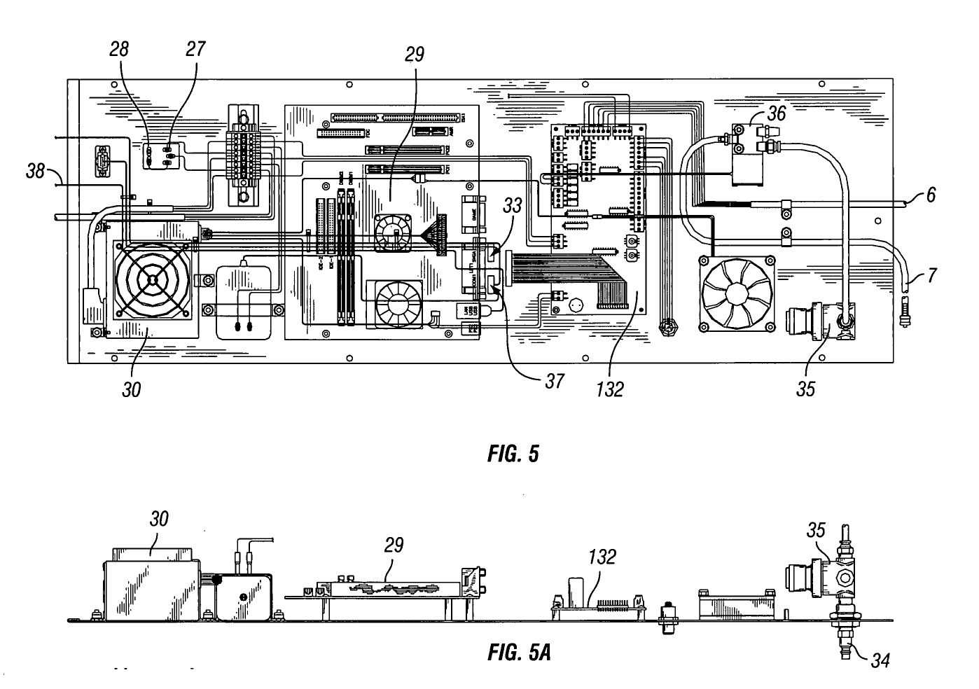

In operation, cables 3 transmit electric signals from, as seen in FIG. 2, the switches 15 and sensor 14 to the system control console that is detailed in FIG. 5 and will be-discussed more fully below. Referring again to FIG. 2, pneumatic hoses 20 are connected to the hoses 4 of FIG. 1 and provide air pressure from the system control console of FIG. 5 (via hose 7) to the centering cylinders 21 of FIG. 2 via hoses 20. Referring again to FIG. 1, ramps 100 and 101 are further electrically connected to the console pedestal 1 and the system control console 2 by electric cables 6 contained within the ramp-to-pedestal interconnect housing 8.

Each ramp 100 and 101 in the illustrated example comprises an approach section 9, a suspension settling section 10, a sensor section 11 or 12, and a departure section 13. Each section is mechanically connected to an adjacent section such that the sections form a single, continuous ramp surface for a tire to travel. In an alternative example, approach and departure sections 9 and 13 are missing, while settling sections 10 and sensor section 11 and/or 12 are substantially flush with or even recessed from surface 19. In still another example, seen in FIG. 1A, settling sections 10 are missing, and ramps 9 and 13 are connected directly to sensor sections 11 and 12.

In many examples, the approach ramp section 9 is constructed as a wedge-shape housing and provides a gradual transition for a vehicle from the solid floor surface 19 to the suspension settling section 10. The suspension settling section 10 is constructed as a rectangular-shape housing and provides a level surface for the vehicle suspension to settle before the sensor section 11 or 12.

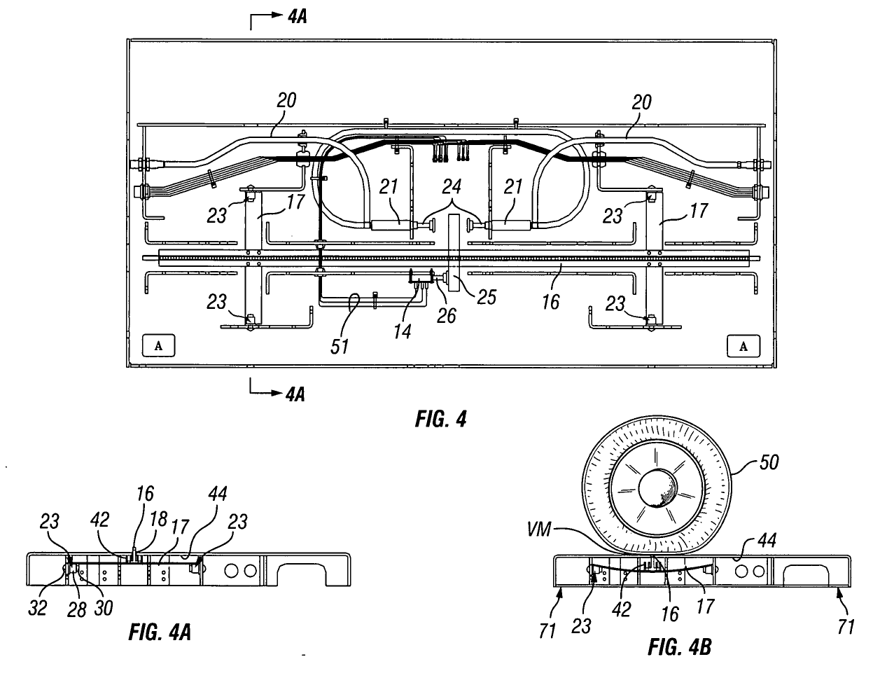

As seen in FIGS. 4A and 4B, when a vehicle tire 50 rolls over the sensor bar 16, the downward movement of the sensor bar 16 bows springs 17. Referring now to FIG. 2, trip switches 15 are contacted upon the downward travel of sensor bar 16 and send at least one signal to the computer in console pedestal 1 of FIG. 1 via wires 6 (see also, FIG. 5) that triggers various functions. In many examples, trip switch 15 is located in the right sensor section 12 in the embodiment of FIG. 1. In at least one alternative embodiment, trip switch 15 is located in the left sensor section 11. In still a further example embodiment, a trip switch 15 is located in both sensor sections 11 and 12.

An example of an acceptable switch 15 is seen in FIG. 2B, in which switch 15 comprises a water-proof limit-switch mounted to housing bracket 38 by rivet 40. Spring 36 of switch 15 is contacted by sensor bar 16 and activates switch 15 by pressing button 34, thus allowing for vertical travel by the sensor bar 16 beyond the point of activation of switch button 34 by spring 36.

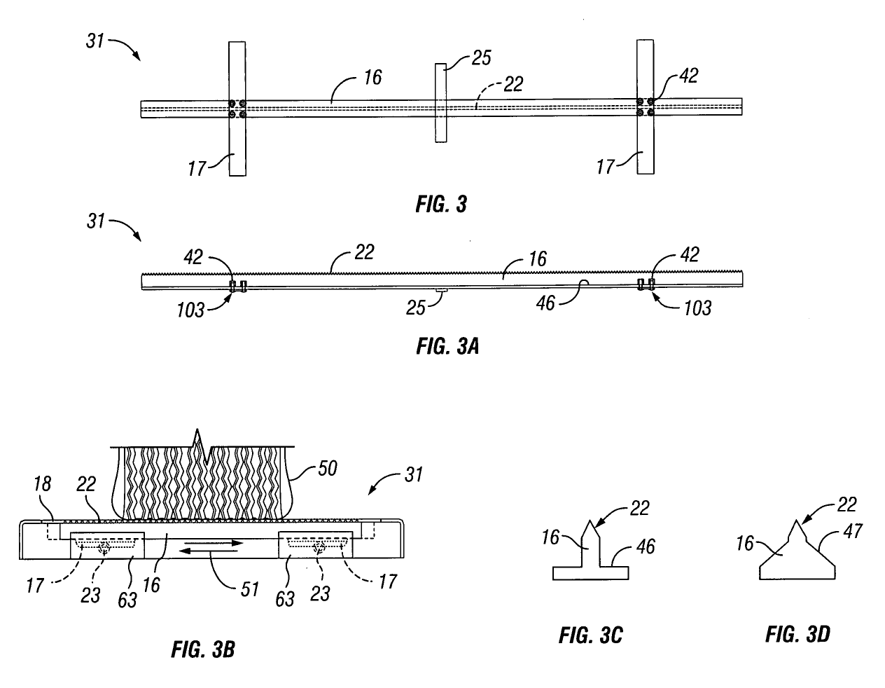

Referring again to the examples of FIGS. 1 and 1A, the sensor sections 11 and 12 are constructed as rectangular-shape housings 11 and 12 (for example, of steel, aluminum, plastics, composites, etc.) and provide for the mechanical connection to an exit ramp section 13, to the ramp interconnect housing 5, and the ramp-to-pedestal interconnect housing 8. In the illustrated example, each sensor section 11 and 12 houses a sensor bar mechanism (FIGS. 3 and 3A), a reset mechanism (seen in FIG. 2 as opposing air cylinders 21), and a linear analog sensor device 14 (also in FIGS. 2 and 4). Referring now to FIGS. 3, 3A-3D, an example sensor bar mechanism is seen in which sensor bar 16 is seen with serrated teeth 22 and sensor bar support springs 17. The sensor bar 16 extends, in at least one example, vertically through a slot 18 (FIGS. 1 and 1A) in the top of the sensor sections 11 and 12. Seen in FIGS. 2 and 4, the sensor bar support springs 17 reside on rollers 23 that are mechanically attached (for example, by screws) to brackets of the sensor housing. As seen in FIGS. 3 and 3A, the springs 17 are connected to the sensor bar 16 by rivets 103 that hold nylon standoffs 42 (described in more detail, later). In some example embodiments, other means for attaching various components mentioned above comprise screws, welds, glues, etc.

Referring now to FIGS. 4A and 4B, in at least one operation of the illustrated example, the sensor bar 16 is forced downward by a vehicle tire rolling over it; the depression of the sensor bar 16 is made possible by the flexibility of the sensor bar support springs 17. Sensor bar 16 is then deflected (or “scuffed”) horizontally as seen in FIG. 3B by movement of tire 50. Such movement occurs due to a variety of causes; and, in some examples, it is represented as an angle of the tire orientation to the travel path. Other indicators are used in further examples of the invention.

FIG. 4, which does not show switch 15 for the sake of simplification, shows the sensor bar mechanism with springs 17 off-center from rollers 23 (compare to FIG. 2). Sensor 14, connected via member 26 to member 25, senses the horizontal defection and sends signals via wires 51 to computer 2. Referring still to the example of FIG. 4, opposing air cylinders 21 reset, or center, the sensor bar mechanism of FIG. 3. The air cylinders 21 are mechanically attached to the interior of the sensor section housings 11 and 12. When air pressure is applied to the air cylinders 21, the piston rods 24 of the air cylinders 21 extend, pushing against member 25 that is attached to the sensor bar 16 (see also, FIG. 3A) and moving the sensor bar 16 to the center of its travel range. Other means for resetting the sensor bar mechanism will occur to those of skill in the art.

In some examples, sensor 14 comprises a commonly available mechanical motion-to-voltage converter. The sensor 14 is attached in the illustrated example by any means that will occur to those of skill in the art (for example, via rivets, screws, and/or other connectors, to brackets of the housing 11 and 12). In some example embodiments, sensor 14 comprises an analog sensor; in some embodiments, sensor 14 comprises a digital or even hybrid sensor; in still further examples, sensor 14 comprises a mechanical device. In even further examples, optical motion sensors are used, while, in still further examples, electrical or magnetic motion sensors are used. Other means for sensing lateral motion of sensor bar 16 will occur to those of skill in the art.

Referring now to FIG. 4, in some examples, rollers 23 comprise brass bushings 28 on stand-offs 30, held by screws 32 (FIGS. 2A and 4A). Other means for providing lateral motion of a biasing means (e.g., springs 17) will occur to those of skill in the art.

In operation of at least one example, a means for retaining sensor bar 16 in an appropriate pre-test lateral position includes friction between the sensor bar 16 and the inside of the sensor section housing 11 and/or 12 to hold the sensor bar 16 in position laterally until the sensor bar 16 is depressed by a vehicle tire rolling over it. In the illustrated example of FIGS. 3A and 3C, nylon standoffs 42 reside between the underside 44 of sensor housings 11 and 12 and horizontal portion 46 of sensor bar 16. Standoffs 42 are held by rivets, screws, and/or other connectors that will occur to those of ordinary skill.

When the sensor bar 16 is depressed, the friction between the sensor bar 16 and the underside of the sensor section housing 11 and/or 12 is released allowing the sensor bar 16 to move laterally on the spring support rollers 23 in reaction to the lateral force applied by a vehicle tire.

Referring again to FIG. 1, the departure ramp section 13, in the illustrated example, comprises a wedge-shape housing and provides a gradual transition for a vehicle from the sensor section 11 and/or 12 back to the solid floor surface 19. Of course, in alternative examples, sensor section housings 11 and 12 are substantially flush with ground level (other components being recessed or located in a different spot and merely being interconnected by power and control signals). Console pedestal 1 supports a system control console (an example of which is illustrated in FIGS. 5 and 5A) which comprises, in some embodiments, an electrical power input receptacle 27, system on-off switch 28, system control panel 29, low voltage power supply 30, computer system 31, analog and digital interface electronics 132, color video display interface 33, system printer interface 37, supply air input quick disconnect fitting 34, air pressure regulator 35, air control solenoid valves 36, access ports 38 for accessories and test equipment, and interconnecting wiring 6 and hoses 7.

The system control console of FIGS. 5 and 5A provides access to various functions of the system (for example, system printer activation). The low-voltage power supply 30 provides power for the computer system 29 and the analog and digital interface electronics 132. The computer system 29 provides direct control of the color video display 2 at computer system 29 and the system printer.

In the illustrated example, analog and digital electronic interface 32 provides at least one example means by which the computer system 29 monitors the input and controls switches 15 and sensors 14 (as well as controlling the output relays and other components that provide power to the air control solenoid valve 36). In some examples, output relays and air pressure sensors are used for the optional tire pressure control and are integral with the analog and digital interface electronics 132. Wiring from the computer system 29, air control solenoid valves 36, access ports, and cables 3 and 6 from the ramps 100 and 101 are connected to the analog and digital interface 32. In a further example, computer system 29 and interface electronics 132 are replaced by a single-board computer system comprising embedded computer technology. This provides the advantage of more ease of assembly. It has been found that so-called “PC” components are not sufficiently standardized and embedded computer technology addresses this significant problem, thus allowing systems to be more reliably produced, more accurate, and easier to maintain.

In operation of the illustrated example, 120 vac external power is connected to the electrical power input receptacle 27 and a 125 psi external air supply is connected to the supply air input quick disconnect fitting 34. The system is then activated by moving the system on-off switch 28 to the “on” position. The computer system 31 is programmed, at power initiation, to perform various system tests and send a reset signal to an air control solenoid valve 36 which causes air pressure to be applied to the pneumatic hoses 4 (FIGS. 1-5). The pneumatic hoses 4 and 7 are connected to the reset mechanism in the sensor sections 11 and 12, as best seen in FIGS. 1 and 1A, of both ramps 100 and 101. The system then enters into its “main routine.”

In its “main routine,” the computer system 31 monitors the trip switches 15 as well as various other system components (connected to the analog and digital interface 132) for selecting other wheel measurements that may be made at the same time (for example, camber measuring, tire pressure equalization, etc.).

Upon detection of a vehicle tire rolling over the trip switch system 15, the system of the illustrated example enters into its tire wear detection mode in which the computer system 31 additionally monitors the linear analog sensor devices 14 in both the left sensor section 11 and right sensor section 12.

After detection of a vehicle tire activating the trip switch 15, the computer system 31 records the signal values received from the linear analog sensor devices 14 and uses these values as the “beginning” or zero values for the vehicle tires then on the ramps 100 and 101 to be analyzed. Using such values results in more accurate and repeatable measurements over prior art systems in which beginning values were recorded from a separate switch section (e.g., in settling sections 10). Positioning of switches 15 to be activated upon contact of sensor bar 16 by a tire, it has been found, does not lose too much data to make an accurate reading.

The computer system continues to monitor the sensor devices 14 until the tire releases pressure from the sensor bar 16 (FIG. 3) and the trip switches 15 are released. The computer system 29 records the signal values received from the sensor devices 14 and uses these values as the “ending” values for the vehicle tires being analyzed. Such a system allows for accurate, repeatable measurements.

The computer system 29 then compares the “ending” and “beginning” values it recorded and calculates the tire wear values for the vehicle tires on each of ramps 100 and 101. In at least some embodiments, the tire wear values are calculated from the ending and beginning balances. Various relationships are used for the calculating, depending on the type of tire, vehicle, etc.

The tire wear values are recorded and displayed on the color video display 2 in the form of numbers, in some examples. In further examples, a colored graphic representation of the appropriate vehicle tires is displayed on the color video display for easy recognition of the tire wear conditions with a green color indicating a more optimum tire wear condition, an amber color indicating a less optimum tire wear condition, and red indicating a relatively poor tire wear condition.

The sequence of detecting a vehicle tire rolling over the ramps 100 and 101, activating the trip switch 15, recording and comparing of “beginning” and “ending” signal values from the linear analog sensor devices 14, calculating the tire wear values, and displaying the results on the color video display 2 is then repeated in some embodiments. The computer system 29 is programmed to send a reset signal to operate the reset mechanism 21 in the left sensor section 11 and the right sensor section 12 after the vehicle tires on the last axle of the vehicle has been analyzed.

In some examples, after the vehicle tires on all axles of interest of the vehicle have been analyzed and the results displayed on the color video display 2, the computer system 29 initiates a waiting period timer for approximately five minutes. During this waiting period, the results of the current vehicle analyzed continue to be displayed on the color video display 2 and the results can be printed on the optional system printer. Other functions of the system may also be utilized during this waiting period such as a camber measuring system and/or a tire pressure equalization system.

Referring again to FIGS. 1A and 2, according to at a further example of the invention, a method and system are provided for determining a tire angle θ to a travel path TP of a tire 50 that is representative of the tendency of the tire 50 to side slip. The method will be understood by reference to the illustrated example, in which the system comprises means 15 for detecting tire 50 at sensor bar 16, means 23 for allowing the sensor bar 16, when in contact with tire 50 and with the tire 50 in a loaded state, to move in a substantially horizontal direction to the travel path TP, and means 29 for recording horizontal motion of the sensor bar 16 as a response to the means 15 for detecting. As used in this document, “a loaded state” refers to the normal loading a tire experiences when in motion. In many examples, a car is rolled over the sensor, which results in the tire being in a loaded state. Further means for contacting sensors 16 with a tire in a loaded state will occur to those of skill in the art.

In a further example, an additional means at sensor station 11 is also provided for terminating the recording in response to loss of contact between the tire 50 and the sensor bar 16. In at least some such examples, the sensor station 11 comprises means 36 for activating a switch 15 responsive to vertical motion of the sensor bar 16. In at least one alternative embodiment, the sensor station comprises a photo switch positioned to be obscured by tire 50 upon contact by the tire with the sensor bar 16. Other means for detecting will occur to those of skill in the art.

Referring again to FIG. 1A, according to still a further example, a means for detecting a further tire 50 at a further sensor bar 16 is seen as sensor station 12. According to still another example, a means for determining a representation of side-slip or scuff, here the tire angle θ to a travel path TP of the further tire 50 at station 12, dependant upon recording the horizontal travel of sensor bar 16 in station 12, comprises the computer system in pedestal 1. A means for displaying of the travel path TP of the tire 50 and the tire angle θ in contrasting colors (for example, red, yellow, and green) is also seen as computer display 2. In at least some examples of the invention, the means for displaying also displays the angle of the second tire crossing ramp 101 substantially simultaneously with displaying of the travel path TP of the tire 50 of ramp 100; and, in still further examples, all tire angles to the travel path of a vehicle are shown substantially simultaneously.

Referring now to FIGS. 3, 3A, and 3B, a specific example of a tire measurement device 31 is seen comprising: a sensor bar 16 having a sensing direction of travel 51 (FIG. 3B) that is at a non-zero angle (in this case, substantially normal) to an anticipated travel path TP. In at least some other examples, the sensing direction of travel 51 is at a more acute angle to the travel path TP. Other angular arrangements between the travel path and sensing direction of travel 51 will occur to those of skill in the art.

In the illustrated example, the measurement device 31 comprises an elongate member 16 having a rough tire-engagement edge 22; in some cases, edge 22 comprises a cerated edge and, in some cases, edge 22 is saw-toothed. Other shapes for engaging tire 50 will occur to those of skill in the art. As seen in FIG. 3C, sensor bar 16 comprises a substantially inverted T-bar in cross-section, although in at least some alternative examples, sensor bar 16 has a variety of shapes (for example, an L-shape, as in some previous patents). In still further examples, as seen in FIG. 3D, sensor bar 16 includes deflectors 47 that prevent fluids and or debris from accumulating on a horizontal surface (e.g., surface 46 of FIG. 3C) of an inverted T-bar.

In the example of the Figures, sensor bar 16 has an activation direction of travel that is different from the sensing direction of travel; in this example, switch 15 is activated by vertical motion of the sensor bar 16 when a tire 50 presses down on it. In at least some other examples, a switch may be activated by motion of the sensor bar 16 in the same travel path as tire 50 presses into sensor bar 16. Leaf springs 17 bias sensor bar 16 in an at least partially vertical direction; in other examples, however, the means for biasing sensor bar 16 may comprise coil springs and/or other means for biasing that will occur to those of skill in the art. Also, embodiments of the invention having further activation directions and/or means for activation of the measurement of sensor bar 16 upon contact with tire 50 will occur to those of skill in the art.

FIGS. 2 and 4 also illustrate a means of returning sensor bar 16 to a center after tire 50 has past. In the illustrated example, opposing air cylinders 21 activate upon the clearing of switch 15 when sensor bar 16, by the action of springs 17, is lifted. In further example embodiments, a single piston with a cam is used (e.g., as illustrated in U.S. Pat. No. 5,522,144, incorporated herein by reference), while in still further examples, opposing springs may be used. Further sensor bar 16 returns to a substantially neutral or “zero” position will occur to those of skill in the art.

Referring again to the illustration in FIG. 4, measurement component 14 of sensor bar 16 is positioned to generate a signal on wires 51 representative of lateral motion of the sensor bar 16 to the deflected position to the right seen in FIG. 4 as compared to the “zero” position of FIG. 2.

Referring now to FIG. 4B, in some examples, a base plate 71 is attached to the various sections 9, 10, 11, 12, and 13 as a leveler when used in combination with a leveling substance (e.g., cementitious material, grout, and/or epoxy or other materials that will occur to those of skill in the art) and to avoid gouging the floor 19 (FIG. 1) of a garage or other service department.

It will be understood that the materials of construction vary widely in various embodiments of the invention, including carbon steel, stainless steel, plastics, composite materials, etc. In some example embodiments, the components are pre-manufactured according to close-tolerance specifications with male/female connectors to make assembly of the system more accurate.

The above is given by way of example only. Other example embodiments of the invention will occur to those of skill in the art without departure from the scope of the patent. It is the intent that the invention is to be limited only to the definitions of the invention set forth in the claims and the equivalents of those definitions. Unless expressly stated in this document, nothing is intended as a definition of any word or phrase that is different from the ordinary meaning of the word or phrase.

1. A tire measurement device comprising:
a tire-engaging sensor having a sensing direction of travel that is at a non-zero angle to an anticipated travel path,
a tire-engaging sensor measurement component positioned to generate a signal representative of movement by the sensor along the sensing direction of travel, and
a switch positioned and arranged for activation of an activation signal upon a tire reaching the sensor.

2. A device as in claim 1 wherein said tire-engaging sensor comprises an elongate member having a rough tire-engagement edge.

3. A device as in claim 2 wherein said tire-engaging sensor has a sensing direction of travel that is substantially perpendicular to the anticipated travel path.

4. A device as in claim 2 wherein said sensor comprises a substantially inverted T-bar in cross-section.

5. A device as in claim 2 wherein said sensor further comprises debris deflectors.

6. A device as in claim 2 wherein said tire-engaging sensor has an activation direction of travel different from the sensing direction of travel.

7. A device as in claim 6 wherein said activation direction of travel is substantially vertical.

8. A device as in claim 6 wherein said tire-engaging sensor is biased in an at least partially vertical direction.

9. A device as in claim 8 wherein said bias comprises:
a first spring mounted between a first end of said sensor bar and a first spring mount of a sensor station and
a second spring mounted between a second end of said sensor bar and a second spring mount of a sensor station.

10. A device as in claim 9 wherein said springs comprise leaf springs.

11. A device as in claim 9 further comprising spring rollers attached to the spring mounts whereby the springs are capable of lateral sliding along the rollers.

12. A device as in claim 2 having a sensor return.

13. A device as in claim 12 wherein said sensor return comprises at least one piston positioned between the sensor and a piston mount on the sensor station.

14. A device as in claim 12 wherein said sensor return comprises a bias.

15. A device as in claim 1 wherein said switch is positioned for activation by a vertical motion of the sensor.

16. A device as in claim 1 wherein
said switch comprises a limit switch positioned for activation by a downward motion of said sensor and generating a signal as a result of the downward motion, and
said switch and said sensor measurement component are connected to a sensor measurement component recorder.

17. A device as in claim 1 further comprising:
a further tire-engaging sensor having a sensing direction of travel that is at a non-zero angle to the anticipated travel path of a substantially parallel tire,
a further switch positioned and arranged for activation upon a the substantially parallel tire reaching the further tire-engaging sensor.

18. A device as in claim 1 further comprising:
a sensor housing having a vehicle-weight-carrying top in which a slot has been formed wherein said tire-engaging sensor protrudes from the slot and
the switch is connected to the sensor housing, under the vehicle-weight-carrying top, sensitive to vertical motion of the sensor.

19. A device as in claim 18 further comprising an approach ramp connected to the sensor housing.

20. A device as in claim 19 further comprising an exit ramp connected to the sensor housing.

21. A device as in claim 18 wherein the sensor housing further comprises a base plate.

22. A device as in claim 18 further comprising sensor a sensor housing leveler.

23. A device as in claim 22 wherein said sensor housing leveler comprises a base plate and filler.

24. A sensor station for tire measurement comprising:
a sensor housing having a slot therein,
a sensor protruding through the slot,
a switch mounted in the sensor housing and activated upon tire-induced motion of the sensor, and
a sensor monitor mounted in the sensor housing and having a signal output representative of motion of the sensor along the slot for recording in response to activation of the switch.

25. A sensor station as in claim 24 wherein said housing further comprises a base including a base plate.

26. A sensor station as in claim 24 wherein said sensor comprises an elongate plane having a top, tire-engaging edge wherein the plane is connected to a support plane along a bottom edge.

27. A sensor station as in claim 26 wherein said sensor further comprises deflectors over the support plane.

28. A sensor station as in claim 24 further comprising a friction contact between said sensor and said housing.

29. A sensor station as in claim 28 wherein said friction contact resides between stand-offs attached to the sensor and the sensor housing.

30. A system for tire measurement comprising:
a left tire-scuffing sensor section,
a right tire-scuffing sensor section, and
a display of information dependant upon readings from the left and the right tire-scuffing sensor stations,
wherein the information display from sensor stations is begun by the contacting of at least one tire to at least one scuffing sensor while the tire is in a loaded state.

31. A system as in claim 30 further comprising a computer monitoring the left and the right tire-scuffing sensors and displaying the information.

32. A system as in claim 30 wherein the information display from each sensor station begins upon contact of a tire with a sensor contained within the specific sensor within each sensor section.

33. A method for determining tire tendency to side-slip, the method comprising:
detecting a tire at a sensor,
allowing the sensor, when in contact with the tire and with the tire in a loaded state, to move in a substantially horizontal direction to the travel path of the tire, and
recording, as a result of said detecting the tire at the sensor, horizontal motion of the sensor.

34. A method as in claim 33 further comprising terminating the recording in response to loss of contact between the tire and the sensor.

35. A method as in claim 33 wherein said detecting comprises activating a switch responsive to vertical motion of the sensor.

36. A method as in claim 33 further comprising:
detecting a further tire at a further sensor,
allowing the further sensor, when in contact with the further tire and with the further tire in a loaded state, to move in a substantially horizontal direction to the travel path of the further tire, and
recording horizontal motion of the further sensor as a result of said detecting the further tire at the further sensor.

37. A method as in claim 33 further comprising determining a tire angle to a travel path of the tire dependant upon said recording.

38. A method as in claim 33 further comprising displaying of travel path of the tire and the tire angle in contrasting colors.

39. A method as in claim 33 further comprising:
determining a further tire angle to the travel path of a further tire on an axle in common between the tires, and
displaying the further tire angle to the travel path substantially simultaneously as the displaying of the travel path of the tire.

40. A method as in claim 39 further comprising displaying multiple tire angles to the travel path of a vehicle substantially simultaneously.

41. A method as in claim 40 further comprising displaying multiple angles in contrasting colors.

42. A system for determining tire tendency to side-slip, the system comprising:
means for detecting a tire at a sensor,
means for allowing the sensor, when in contact with the tire and with the tire in a loaded state, to move in a substantially horizontal direction to the travel path of the tire, and
means for recording horizontal motion of the sensor as a result of said detecting.

43. A system as in claim 42 further comprising means for terminating the recording in response to loss of contact between the tire and the sensor.

44. A system as in claim 42 wherein said means for detecting comprises means for activating a switch responsive to vertical motion of the sensor.

45. A system as in claim 42 further comprising:
means for detecting a further tire at a further sensor,
means for allowing the further sensor, when in contact with the tire and with the tire in a loaded state, to move in a substantially horizontal direction to the travel path of the tire, and
means for recording horizontal motion of the further sensor dependant upon said means for detecting the further tire.

46. A system as in claim 42 wherein said means for recording comprises a moving disk.

47. A system as in claim 42 wherein said means for recording comprises embedded computer memory.

48. A system as in claim 42 further comprising means for determining the tire angle to a travel path of the tire dependant upon said means for recording.

49. A system as in claim 48 further comprising means for displaying of travel path of the tire and the tire angle in contrasting colors.

50. A system as in claim 42 further comprising:
means for determining a further tire angle to the travel path of a substantially parallel tire and
means for displaying the further tire angle to the travel path substantially simultaneously as the displaying of the travel path of the tire.

51. A system as in claim 50 further comprising means for displaying all tire angles to the travel path of a vehicle substantially simultaneously.

52. A system as in claim 51 further comprising means for displaying all angles in contrasting colors.
